(19) United States
(12) Patent Application Publication
(10) Pub. No.: US 2020/0140757 A1
(43) Pub. Date: May 7, 2020

(54) CELLULOSE DERIVED HYDROPHOBIC, BIO-DEGRADABLE FILMS FOR MULCH & OTHER APPLICATIONS

(71) Applicant: Rayonier Performance Fibers, LLC, Jacksonville, FL (US)

(72) Inventor: Sabornie CHATTERJEE, Richmond Hill, GA (US)

(73) Assignee: Rayonier Performance Fibers, LLC, Jacksonville, FL (US)

(21) Appl. No.: 16/178,944

(22) Filed: Nov. 2, 2018

(51) Int. Cl. C09K 17/52

(52) U.S. Cl. CPC C09K 17/52; C08L 1/02

(57) ABSTRACT

The present invention describes synthesis and properties of cellulose based biodegradable hydrophobic mulch film for agricultural applications. The invented method can also be used to obtain an highly hydrophobic mulch film. Cellulose, the most abundant natural polymer is chemically modified to make bio-degradable, mulch films that are partially air permeable but water impermeable. The water impermeability can be changed by varying the processing conditions. The film can be multi-functional; that is besides providing the water impermeability the film can also be customized to adjust the pH of soil and to deliver herbicides or fertilizers to the soil. Other lignocellulosic materials or different combinations of synthetic fibers, fabrics or polymers and cellulose materials including newsprint can also be used to make the biodegradable hydrophobic film. Additionally, the invention can be used to make biodegradable extremely hydrophobic self-cleaning products for other hydrophobic applications such as packaging materials or disposable water-proof clothing.

### BACKGROUND OF THE INVENTION

### (1) Field of Invention

The present invention generally relates to cellulose based materials for agricultural and landscaping applications but can also be used for self-cleaning packaging materials or disposable self-cleaning water-proof clothing. In particular, this invention describes the synthesis and application of lignocellulosic, especially cellulose based bio-degradable mulch films.

### (2) Description of Related Art

There has been a growing demand of biodegradable agricultural mulch films in recent years. Mulch films are used in agricultural lands or in landscaping to conserve water and control weeds. Some specialty mulch films are available that can be used to boost growth of plants by slow release of nutrients, controlling sunlight, trapping toxic gases from soil. Most current mulch films are made from plastics or other polymeric materials. Fluctuations in the price of crude-oil affect the price of mulch films. Additionally, use of plastic mulch film creates environmental hazards as most of these films are not biodegradable. Recycling of plastic mulch films is both labor intensive and time consuming.

The present invention introduces a new product—a cellulose based biodegradable hydrophobic mulch film for agricultural applications. Hydrophobicity and strength of the film can be customized for different applications. The film can also be customized for additional agricultural applications such as controlling the pH of the soil or applying herbicides or pesticides to the soil. Moreover, the invention can also be used to make biodegradable, self-cleaning, extremely hydrophobic products for other non-agricultural applications such as packaging materials or disposable water-proof clothing.

The term “self-cleaning” means removing dirt or other contaminants from a surface by employing its inherent water or other liquids (e.g. oil) repelling tendency. Some self-cleaning surfaces are extremely hydrophobic. Similar to the “lotus effect”, water forms spherical droplets in contact of such extremely hydrophobic self-cleaning surfaces. While rolling away from the surface, those water droplets collect dirt and other contaminants and remove them from the surface.

Cellulose (C₆H₁₀O₅)ₙ, wherein n=10,000-15,000 (see Chemical formula 1), is the structural component of plant cell wall and is the most abundant natural polymer on the earth. One of the major sources of cellulose is wood pulp. The easy availability of cellulose makes the price of cellulose stable and it fluctuates less than the price of crude oil, which is the starting material for synthetic fibers or polymers. Cellulose based biodegradable hydrophobic mulch film does not require manual collection and disposal. Thus, the use of cellulose derived biodegradable hydrophobic mulch film is a cost effective and environment friendly product.

Cellulose has the following general chemical structure:

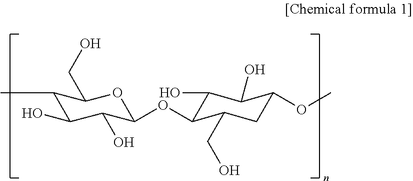

There are only a few descriptions in the prior art, where hydrophobic cellulose materials are used. One patent (WO 17089996A1, 2017) is directed to ‘A ground cover mulch comprising minerals and functional agents’ and reports a mulch type ground cover that is made from lignocellulosic based fibers. The mulch cover can be in sheet or web form.

To protect the paper based cover from biodegradability, microbial attacks and to increase the strength and reduce the cost the product fibers are coated with chemicals such as calcium carbonate, non-carbonized metal hydroxides such as calcium hydroxide, magnesium hydroxide, etc. Further, coloring agents and hydrophobic sizing agents such as alkyl ketene dimer (AKD), alkenyl succinic anhydride (ASA), rosins are also incorporated into the product.

Another patent (U.S. Pat. No. 5,532,298A, 1996) is directed to a “Degradable agricultural mat” and reports a degradable mat made from an aqueous mixture of 20-80% polymer fibers, 20-80% cellulose pulp, a hydrophobic reagent from the group of an alkene ketene dimer, an epichlorohydrin and an alkenyl succinic anhydride.

A third patent (U.S. Pat. No. 9,034,953B, 2018) claims “a surface treatment composition for inkjet media” that has several components in its composition including sizing agents, starch, etc. This invention uses aluminum sulfate octadecahydrate as an ink fixative.

One patent (U.S. Pat. No. 4,877,528A, 1989) reported the use of epoxide siloxanes with cellulose derivatives (ethers, acetates, etc.) to make semi permeable membranes for gas separation.

Chmielewski et al. (US 0354506 A1, 2016) reported a breathable back sheet for disposable absorbent garments. Several patents describing the use of AKD in papermaking are available. A few patents showed use of AKD to modify biomasses for hydrophobic agricultural application including plant pots and mats (e.g. U.S. Pat. No. 5,532,298A, 1996; U.S. Pat. No. 5,853,541A, 1998, etc.). However, in most cases additional petroleum based plasticizers were used.

In a 2007 paper (Rom et al. The Hydrophobization of Cellulose Pulp, Fibers Textiles Eastern Europe, 2007, 15, 64-65), Rom et al. showed the use of alum in presence of sodium salt of fatty acids to render hydrophobicity on cellulose.

However, the instant invention is not described in the above mentioned patents or literature. No patent or literature describes the inventive product or method, where an alkali activation followed by a treatment of an AKD and aluminum sulfate blend are employed to obtain a durable biodegradable hydrophobic product or durable biodegradable hydrophobic, self-cleaning product. Furthermore, no prior record of enhancing the strength of a durable biodegradable hydrophobic product or durable biodegradable hydrophobic, self-cleaning product by incorporation of softwood or isosorbide has been found.

### BRIEF SUMMARY OF THE INVENTION

Due to the presence of multiple hydroxyl groups, cellulose is inherently hydrophilic. A wide range of cellulose based hydrophilic products for different applications have been prepared by chemically manipulating these hydroxyl groups. Similarly, cellulose can be converted to hydrophobic material by chemically modifying these hydroxyl groups. The degree of hydrophobicity can be controlled by changing the reaction conditions. Compared to the natural hydrophilic cellulose, hydrophobic cellulose has been only explored for limited applications.

Historically, silicon reagents, fluorocarbons, hydrocarbons, synthetic sizing reagents, rosin chemicals, etc. have been successfully used to introduce hydrophobicity in cellulose. However, some of these chemicals such as fluorocarbons, some hydrocarbons and silicone reagents are expensive as well as hazardous and toxic in nature.

The present invention introduces cellulose based biodegradable hydrophobic mulch film for agricultural application. The hydrophobicity of the film can be changed depending on the application need. The film can be customized for other agricultural applications such as controlling the pH of the soil or applying herbicides or pesticides or to deliver fertilizers or nutrients to the soil. The film can also be made extremely hydrophobic and self-cleaning to use in application such as packaging and disposable water-proof clothing.

### BRIEF DESCRIPTION OF THE FIGURES

FIG. 1 shows hydrophobicity of modified cellulose prepared by alkali activation followed by the treatment with the blend of 15% AKD and about 3% aluminum sulfate in the form of Fennosize KD 266 MB™ from Kemira.

FIG. 2 shows hydrophobicity of different modified cellulose feedstock prepared by alkali activation followed by the treatment with the blend of 15% AKD and about 3% aluminum sulfate in the form of Fennosize KD 266 MB™ from Kemira.

FIG. 3 shows hydrophobicity of different products based on water repelling duration. AKD (Alkyl ketene dimer), AKD_ALS(emulsified blend of 15% AKD and about 3% aluminum sulfate in the form of Fennosize KD 266 MB™ from Kemira), non-activated (without treatment of sodium bicarbonate), R (showing rose petal effect), L (showing lotus leaf effect). The vertical axis is shown in minutes. All minutes are approximate. After 8 h, most drops loose its major volume due to water evaporation.

### DETAILED DESCRIPTION OF THE INVENTION

The present invention can be used to prepare hydrophobic material from any cellulose or lignocellulosic feedstock such as lignin, hemicellulose, etc. The feedstock can be of any type of cellulose pulps such as cotton, softwood, hardwood or a mixture of any of those. Feedstock can also include all types of dissolving pulps and chemical pulps such as bleached, unbleached, partially bleached or half bleached Kraft, soda or sulfite pulps and mixture of any of those.

A mix of cellulose and synthetic, polymeric, bio-based or textile fibers can also be used as the feedstock. Agricultural (e.g. potato, bagasse, etc. derived) or grass (e.g. bamboo, switch grass) based cellulose can be used as the starting material as well. Any other forms of cellulose such as nanocrystalline cellulose (NCC), microcrystalline cellulose (MCC), micro fibrillated cellulose (MC), cellulose whiskers, amorphous cellulose, thermo mechanical pulp, new or recycled newsprints, regenerated cellulose of any kind or any modified form of any of those can also be used as the feedstock or as a feedstock blend.

The strength of mulch film can be increased by using softwood (100% softwood) or a blend of softwood (20% softwood and above) and other cellulosic material as the feedstock.

The strength of the film can also be increased by adding 4-20 weight % isosorbide to the cellulose in the form of aqueous solution before the activation stage.

The mulch film is prepared by activating the cellulosic feedstock by treatment with (2-10%) aqueous ammonium hydroxide or sodium bicarbonate solution. The activation can also be performed using other basic or alkali solutions such as sodium hydroxide (NaOH), sodium carbonate (Na₂CO₃) aqueous solutions with varying concentration (0.5% and higher), etc. Furthermore, any reagent such as tertiary amines, other organic bases, etc. that would be able to generate a nucleophile on cellulose based starting material can also be used as an activating agent. Activation can be conducted at the room temperature under normal atmospheric pressure. Additionally, the activation can be achieved under a wide range of temperature (10-50° C.) under normal atmospheric pressure.

Activation of the cellulosic material with alkali or basic solutions generates nucleophiles on cellulose, which then react with hydrophobizing reagents to form hydrophobic material. Activation can be performed on any form such as film, granules, powder, etc. of cellulose materials. For Agricultural application, use of cellulose derived film or newsprint type material may be useful.

The degree of hydrophobicity of the product can be customized by tuning the activation time or the concentration of the alkali solution. For obtaining extremely high hydrophobicity and self-cleaning property, 6-10% alkali solution is needed. Alkali treatment enhances hydrophobicity of the product by increasing the surface roughness and reducing the surface energy. Moreover, use of alkali treatment facilitates the incorporation of AKD and increases hydrophobicity. Thus, alkali activation of cellulose has multiple roles in enhancing the tunable hydrophobicity of the cellulose film. The material prepared using alkali activation stage will have higher hydrophobicity than a material prepared using same procedure and same chemicals without the activation stage.

The activated material is treated with alkyl ketene dimer (AKD) or an emulsified blend of alkyl ketene dimer and aluminum sulfate in the form of Fennosize KD 266 MB™ from Kemira. The product can also be made using other hydrophobic or sizing agent such as alkyl succinic anhydride, epichlorohydrin, etc. or a combination of any of those.

Hydrophobization can be conducted at the room temperature under normal atmospheric pressure. Additionally, the activation can be achieved under a wide range of temperature (10-50° C.) under normal atmospheric pressure.

Hydrophobization can be performed on any form such as film, granules, powder, etc. of cellulose materials. For Agricultural application, use of cellulose derived film or newsprint type material may be useful

AKD is a waxy compound mostly used in pulp and paper industry as a hydrophobizing agent. AKD is in general used in an emulsified form at the wet end of the pulp process. Use of aluminum sulfate facilitates the interaction between AKD and cellulose based material.

For this invention, AKD with a wide range of alkyl and alkylidene groups containing eight or more carbons can be used. High hydrophobicity is achieved with AKD having alkyl and alkylidene groups with twelve to twenty carbons.

The concentration of AKD in the emulsion can be varied from 0.5%-20%. Use of 8-10% aq. solution of emulsion containing AKD (>15%) or an emulsified blend of AKD (>12%) and aluminum sulfate (>3%) will generate extremely high hydrophobicity and self-cleaning property in the film. Different combinations of AKD and aluminum sulfate such as—AKD (10%)-aluminum sulfate (4%), AKD (12%)-aluminum sulfate (3%), AKD (15%)-aluminum sulfate (2%), AKD (10%)-aluminum sulfate (4%) and so on and AKD (10-15%), alkenyl succinic anhydride (ASA) (4-15%), blends of ASA and AKD with varying concentrations or any combinations of those hydrophobizing agents in an emulsified form or a solution form can be used. Depending of the nature of soil, the concentration of aluminum can be varied from (0-5%).

Different blends containing higher amount of aluminum sulfate and lower amount AKD will also generate hydrophobic material. The hydrophobicity and self-cleaning performance of the material depend on the combination of hydrophobizing agent and degree of activation using alkali solution. By using a stronger alkali activation and highly concentrated AKD and aluminum sulfate treatment, a superhydrophobic, self-cleaning film can be prepared. The hydrophobicity and self-cleaning property of the film can be changed by tuning the combination of hydrophobizing agent and degree of alkali activation.

After the treatment of alkyl ketene dimer (AKD) or AKD and aluminum sulfate, the wet product is then thermally dried at 105° C. for 5 minutes to generate the hydrophobic material. The drying can be achieved using various temperatures, various heating times or other thermal treatments. Use of a lower temperature will increase the drying time.

The above mentioned method can be modified to make colored hydrophobic material, where different colors such as Jet Black, Brown BL, Green V, Red GTL, etc. from OrcoFlor LF™ Dyes can be added to the activated cellulosic material during the addition of alkyl ketene dimer (AKD) or alkyl ketene dimer and aluminum sulfate.

Biodegradable hydrophobic mulch film can be used for other agricultural applications in different ways—

i) Herbicides, nutrients or fertilizer delivery system—by adding weed killing chemicals, nutrients, fertilizers etc., on the soil-facing side of the film. Aqueous solution of herbicides such as the mixture of Dicamba+2,4-D can be incorporated on the soli-facing side of the film by spray and dry method. Similarly, fertilizer solution consisting N-P-K (nitrogen, phosphorus and potassium) can also be added on the soil-facing side of the film using a spray and dry method. The film should be installed in a way so that the surface containing herbicides or fertilizer should face the soil while the surface with hydrophobicity should be open in the air. This way, mulch film can be used to control weeds or to provide fertilizer to the soil.

ii) pH enhancer of the soil-by using excess alkali/basic reagents during the activation stage. A wide range of alkali or base reagents such as aqueous solutions of ammonium hydroxide, sodium bicarbonate, sodium hydroxide (NaOH), sodium carbonate (Na₂CO₃), etc. can be used. Other organic bases such as dimethyl amine, etc. can also be used.

Additional base/alkali will make the final product alkaline in nature. The basic/alkaline nature of hydrophobic mulch film will able to reduce the acidity of soil once the film bio-degrades and mix with the soil.

iii) pH reducer of the soil: by using excess aluminum sulfate during the chemical treatment stage. Other acidic reagents such as iron sulfate, phosphoric acid, etc. can also be added to the film, especially to the soil-facing surface using spray and dry method. Additional aluminum sulfate or other acidic reagents added to the film will mix with the soil once the film bio-degrades and thus, will be able to reduce the alkalinity of the soil.

The present invention describes the synthesis of biodegradable mulch film that can be used in a granules, roll or sheet form. The granules of the mulch film can be prepared by milling the biodegradable, hydrophobic mulch film. The roll or sheet forms of the mulch film can be prepared by modifying cellulose sheet or roll including newsprint as mentioned above. The roll or sheet forms of the film can be used as a single layer or multiple layers depending on the application.

Moreover, lignocellulose materials including bio-derived biodegradable polymers or biodegradable synthetic polymers or any blend of above materials can be added as filler materials between two layers of the film.

The thickness of the hydrophobic mulch film can vary from 5-150 um (micrometer) based on the nature of plants, soils, atmosphere and other needs. The preferred range of thickness would be 120-135 um.

The mulch film can be laid on the soil manually or by mulch unroller. Depending on the thickness of the sheet, degree of activation, amount of AKD or AKD and aluminum sulfate, amount of softwood or isosorbide, nature of soil and weather the hydrophobicity and durability of the film may vary from 2-6 months. After this duration, the mulch film will start disintegrating from the sides, where the film is in touch with the soil. This eventually will lead to the decomposition of the mulch film. The decomposed film will then mix with the soil. The durability of the mulch film can be customized by changing the composition of the film such as adding more nanocellulose for a longer lifetime. This customization to achieve desired life and performance of the mulch film can be performed using routine experiments.

The biodegradable, self-cleaning, hydrophobic mulch product in roll or sheet form can also be used for other non-agricultural application such as packaging material or disposable waterproof clothing. The method as described above can be used to modify the outer surface of any packaging material, which will make the material hydrophobic and durable. Similarly, high strength paper modified with the method as described above can be converted to a self-cleaning, high hydrophobic material that can be used to make biodegradable disposable water proof clothing such as rain coats or ponchos.

Method of Making the Invention

The core structure of cellulose consists of repeated units of D-glucose that are connected by β-1, 4 glycosidic linkages. Cellulose is highly functionalized due to the presence of several hydroxyl groups. Multiple interactions between hydrogens, hydroxyl groups generate high degree of hydrogen bonding that in turn creates highly structured crystalline regions in cellulose. Due to the coexistence of highly crystalline and amorphous structures, cellulose is a semi crystalline polymer. The high activity of cellulose originates from the presence of three hydroxyl groups in each anhydroglucose unit.

The present invention describes a process by which hydroxyl groups of cellulose can be modified to make cellulose based hydrophobic materials. The primary sources of cellulose for this invention are wood pulps and newsprints. However, the feedstock can be of any type of cellulose pulp such as cotton, softwood, hardwood or a mixture of any of those. Feedstock can also include all types of dissolving pulps and chemical pulps such as bleached, unbleached, partially bleached or half bleached Kraft, soda or sulfite pulps and mixture of any of those. A mix of cellulose and synthetic, polymeric, bio-based or textile fibers can also be used as the feedstock. Agricultural (e.g. potato, bagasse, etc. derived) or grass (e.g. bamboo, switch grass) based cellulose can be used as the starting material as well. Any other forms of cellulose such as nanocrystalline cellulose (NCC), microcrystalline cellulose (MCC), micro fibrillated cellulose (MC), cellulose whiskers, amorphous cellulose, thermo mechanical pulp, new or recycled newsprint, regenerated cellulose of any kind or any modified form of any of those can also be used as the feedstock or as a feedstock blend.

In general, hydrophobicity of a solid surface primarily depends on surface energy and roughness. Hydrophobicity increases with increase in surface roughness and decrease of surface energy. To make any material hydrophobic, it is relatively easier to reduce the surface energy than enhancing the surface roughness. In this invention the surface roughness is introduced by using an alkali activation of cellulose film or sheet. The alkali activation can be done using aqueous solution of sodium bicarbonate, ammonium hydroxide or any other alkaline or basic solution. Historically fluorine or silicon containing polymers have been used to decrease the surface energy of cellulose. Due to the environmental hazards and high cost of those chemicals, the present invention uses alkyl ketene dimer (AKD) or alkyl ketene dimer and aluminum sulfate emulsified blend in the form of Fennosize KD 266 MB™ from Kemira. Any other sizing or hydrophobizing agent such as alkenyl succinic anhydride (ASA), epichlorohydrin in various combinations and concentrations can also be used.

In this invention, the cellulose based biodegradable mulch film is prepared by activating the cellulose sheet by treatment with aqueous sodium bicarbonate solution or ammonium hydroxide solution to simultaneously increase the roughness of the surface and activate the surface followed by the treatment of alkyl ketene dimer (AKD) or alkyl ketene dimer and aluminum sulfate emulsified blend in the form of Fennosize KD 266 MB™ from Kemira to lower the surface energy. Use of sizing reagents such as AKD has been a well-known process for many years. However, use of AKD or the combination of AKD and aluminum sulfate on base activated cellulose or cellulosic materials to make hydrophobic biodegradable mulch film is new.

Chemical formula 2 shows the reaction of cellulose with AKD. The core chemistry of the process involved the capping of cellulosic hydroxyl groups by AKD as shown in the Chemical formula 2.

“R” is an alkyl group with 12-20 carbons.
n=2”

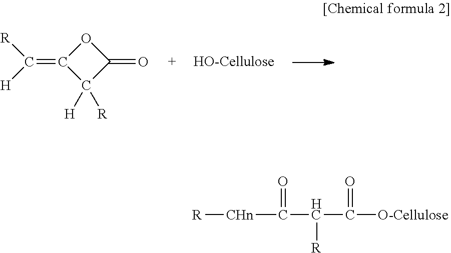

In case of the reaction involving alkyl ketene dimer and aluminum sulfate, the aluminum facilitates the interaction of the AKD with the cellulose hydroxyl group (see Chemical formula 3). Chemical formula 3 shows modification of cellulose surface with aluminum sulfate and AKD.

“R” is an alkyl group with 12-20 carbons.

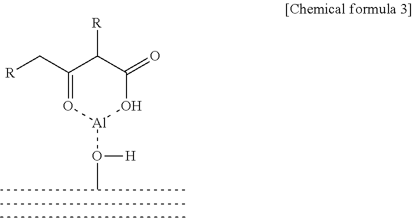

Additionally, some hydrophobicity of modified cellulose may be generated from by the formation of aluminum oxide on cellulose, as shown in Chemical formula 4.

Al₂(SO₄)₃+Cell-ONa=(Cell-O)₃−Al+Na₂SO₄ [Chemical formula 4]

The film of this invention may contain an emulsified blend of an AKD and aluminum sulfate (alum). Other than that the film preferably has no minerals as taught by WO 17089996A1, 2017, the disclosure of which is incorporated herein by reference. Specifically, the film of this invention preferably has no mineral coating over the cellulose fibers.

The film of this invention preferably has no fillers, as taught by WO 17089996A1, 2017, the subject matter of which is incorporated herein by reference.

The film of this invention may contain a synthetic petroleum based polymer, such as incorporated into the product of U.S. Pat. No. 5,532,298A, 1996, the disclosure of which is incorporated herein by reference. Preferably, the film of this invention has less than 20%, more preferably 5-10%, even more preferably 1-5%, and most preferably 0-1%, content of synthetic petroleum based polymer.

The film of this invention preferably has no organic acid salts, as taught by US 2012/164239, the subject matter of which is incorporated herein by reference.

### Experiments and Results

Several experiments were conducted for the hydrophobic functionalization of cellulose:

1) Different cellulose types of cellulose including newsprint, cellulose with high hemicellulose, and cellulose with high lignin content, lignocellulosic materials as mentioned before were used in this work. Any lignocellulosic material functionally similar with cellulose or blends of cellulose or lignocellulosic material and other synthetic or petroleum based polymers can also be used in making of hydrophobic mulch film.
2) Alkyl ketene dimer (AKD) or a blend of alkyl ketene dimer and aluminum sulfate in the form of Fennosize KD 266 MB™ from Kemira are used as hydrophobizing agent in this invention. AKD and aluminum sulfate can also be used separately as an emulsified or aqueous solution. The product can also be made using other hydrophobic or sizing agent such as alkyl succinic anhydride, epichlorohydrin, etc. or a combination of any of those. For this invention, AKD with a wide range of alkyl and alkylidene groups containing eight or more carbons can be used. Good to high hydrophobicity is achieved with AKD having alkyl and alkylidene groups with twelve to twenty carbons. The concentration of AKD in the emulsion can be varied from 0.5%-20%. Use of concentrated (>8%) solution of AKD or emulsified AKD (>15%) or an emulsified blend of AKD (>12%) and aluminum sulfate (>3%) will generate extremely high hydrophobicity and self-cleaning property in the film. Different combinations of AKD and aluminum sulfate such as—AKD (10%)-aluminum sulfate (4%), AKD (12%)-aluminum sulfate (3%), AKD (15%)-aluminum sulfate (2%), AKD (10%)-aluminum sulfate (4%) and so on and AKD (10-15%), alkenyl succinic anhydride (ASA) (4-15%), blends of ASA and AKD with varying concentrations or any combinations of those hydrophobizing agents in an emulsified form or in a solution form can be used. Different Blends containing higher amount of aluminum sulfate and lower amount AKD will also generate hydrophobic material.
3) The general synthetic scheme for the synthesis of hydrophobic cellulosic film for mulch application is as follows:

11.0 g of cellulose (0.25 mol) sheet was cut in a rectangular form, which could be used as mulch film. The same method can be executed on other lignocellulosic material, newsprints or powdered or granular form of cellulose. However, in those cases a sheet needs to be made for this method. The sheet is then treated with 15 mL 6% sodium bicarbonate aq. solution. Other concentration (2-10%) can also be used for this activation. Other alkalis or bases such as ammonium hydroxide, sodium carbonate, sodium hydroxide, potassium hydroxide, etc. can also be used in different concentration for this activation. Treatment of sodium bicarbonate was done through spraying by an airbrush sprayer at a pressure of 25 psi. 2-3 spray passes were used to uniformly activate the cellulose surface. The treatment can also be performed by dipping the sheet in the solution. The cellulose sheet is then pressed with roller to remove excess water. Next, 15 mL of 5% aqueous solution of the emulsified blend containing 15% AKD and 3% aluminum sulfate (Al₂(SO₄)₃) in the form of Fennosize KD 266 MB™ from Kemira is sprayed on the activated sheet by an airbrush sprayer at a pressure of 25 psi. 3-4 spray passes were used to uniformly coat the cellulose surface. The concentration of the emulsified blend of AKD and aluminum sulfate in the form of Fennosize KD 266 MB™ from Kemira in the aq. solution can be varied from 0.5%-10%. The concentration of AKD in the emulsion can be varied from 0.5%-20%. Use of concentrated (>8%) solution of AKD or emulsified AKD (>15%) or an emulsified blend of AKD (>12%) and aluminum sulfate (>3%) will generate extremely high hydrophobicity and self-cleaning property in the film. Different combinations of AKD and aluminum sulfate such as—AKD (10%)-aluminum sulfate (4%), AKD (12%)-aluminum sulfate (3%), AKD (15%)-aluminum sulfate (2%), AKD (10%)-aluminum sulfate (4%) and so on and AKD (10-15%), alkenyl succinic anhydride (ASA) (4-15%), blends of ASA and AKD with varying concentrations or any combinations of those hydrophobizing agents in an emulsified form or in a solution form can be used. Different Blends containing higher amount of aluminum sulfate and lower amount AKD will also generate hydrophobic material. The hydrophobicity and self-cleaning performance of the material depends on the combination of hydrophobizing reagent and degree of activation using alkaline solution. By using a stronger alkaline treatment and high amount of AKD and aluminum sulfate, a superhydrophobic film can be prepared. The hydrophobicity and self-cleaning property of the film can be changed by tuning the combination of hydrophobizing agent and degree of alkaline activation.

For granular or powdered form of cellulosic or lignocellulosic materials, activation and chemical treatment stages can be done using spray, coating or in situ method. The amount of sodium bicarbonate or other alkaline agents, AKD or other hydrophobizing agent, aluminum sulfate, reaction conditions including temperature and drying time can be varied.

Next, the treated sheet was dried at 105° C. for 5 minutes. The drying can be achieved using various temperatures (90-150° C.), various heating times (2-30 min) or other thermal treatments. Use of a lower temperature will increase the drying time.

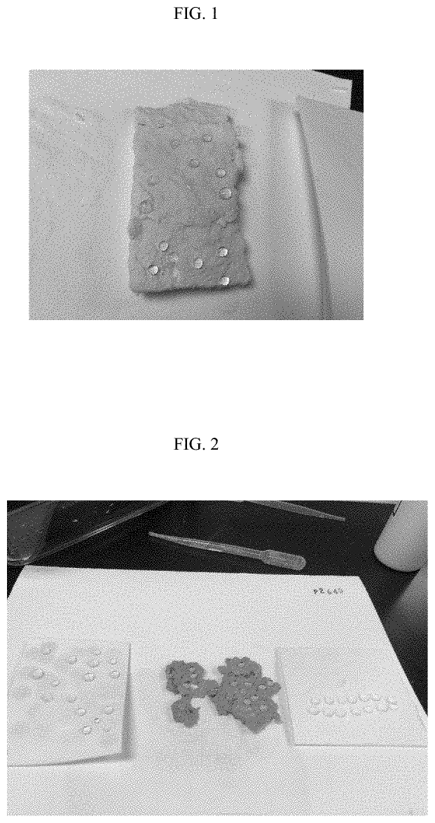

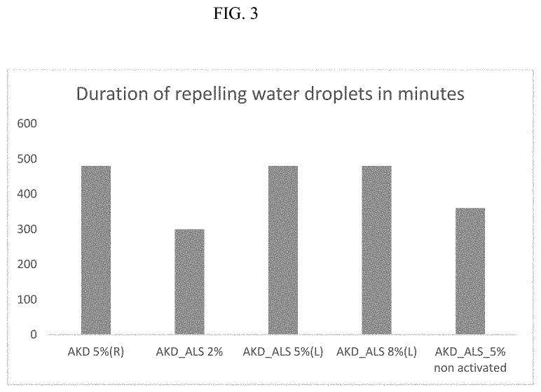

Once dried, the sheet was tested for hydrophobicity by adding drops of water on the surface of the sheet. The product showed excellent hydrophobicity. The cellulose activated with 15 mL 6% sodium bicarbonate aqueous solution and treated with 15 mL 5% aq. solution of emulsion containing 15% AKD in the form of Fennosize KD C125™ from Kemira showed 6-8 h of water repelling capacity in selected regions (FIG. 1). The sheet with 15 mL (6%) alkaline activation and treatment with 15 mL 5% aqueous solution of the emulsified blend containing 15% AKD and 3% aluminum sulfate (Al₂(SO₄)₃) in the form of Fennosize KD 266 MB™ from Kemira showed some lotus leaf (i.e. Cassie-Baxter) type of wetting. On the other hand, with alkaline activation and treatment with 8% aqueous solution of the emulsified blend containing 15% AKD and 3% aluminum sulfate (Al₂(SO₄)₃) in the form of Fennosize KD 266 MB™ from Kemira; the sheet showed lotus leaf (i.e. Cassie-Baxter) type of wetting that can be used for extremely hydrophobic, self-cleaning applications.

4) Different starting materials such as a blend of cellulose with high hemicellulose, cellulose with high lignin or a blend of high yield etc. showed high hydrophobicity after modification following the above method.

### Example 1

Hydrophobization was done by activating the sheet with sodium bicarbonate followed by the treatment with AKD_ALS (i.e. the blend of 15% AKD and about 3% aluminum sulfate in the form of Fennosize KD 266 MB™ from Kemira) reagent. 15 mL 6% NaHCO₃ aq. solution was sprayed on the surface of rectangular cellulose sheet (about 11 g) by an airbrush sprayer at a pressure of 25 psi. The excess water was removed by a roller. Next, 15 mL of 5% aqueous solution of the emulsified blend of 15% AKD and about 3% aluminum sulfate in the form of Fennosize KD 266 MB™ from Kemira was sprayed on the activated surface of the cellulosic material. Three spray passes were used to coat the surface. The product was then dried in oven at 105° C. for 5 mins. In this case, excellent hydrophobicity was obtained.

In general, products obtained with 8-10% aq. solution of the blend of 15% AKD and about 3% aluminum sulfate in the form of Fennosize KD 266 MB™ from Kemira using spray method showed extremely high hydrophobicity featuring lotus leaf type of wetting (FIG. 5). Even products obtained with 5% aq. solution of the blend of 15% AKD and about 3% aluminum sulfate in the form of Fennosize KD 266 MB™ from Kemira showed excellent hydrophobicity and some lotus leaf type of wetting Both products showed water repelling property for at least 8 hours. After 8 hours most water drops were almost evaporated. When AKD_ALS was applied without any prior sodium bicarbonate treatment on cellulose, some absorption was observed after 6 hours (FIG. 6).

### Example 2

Hydrophobization was done by activating the sheet with ammonium hydroxide solution followed by the treatment with AKD_ALS (i.e. the blend of 15% AKD and about 3% aluminum sulfate in the form of Fennosize KD 266 MB™ from Kemira) reagent. In this case, 15 mL 6% NH₄OH aq. solution was sprayed on the surface of rectangular cellulose sheet (about 11 g) by an airbrush sprayer at a pressure of 25 psi. The excess water was removed by a roller. Next, 15 mL of 5% aqueous solution of the emulsified blend of 15% AKD and about 3% aluminum sulfate in the form of Fennosize KD 266 MB™ from Kemira was sprayed on the activated surface of the cellulosic material. Three spray passes were used to coat the surface. The product was then dried in oven at 105° C. for 5 mins. In this case, excellent hydrophobicity was obtained.

### Example 3

Hydrophobization was done by activating the sheet with sodium bicarbonate followed by the treatment with AKD_ALS (i.e. the blend of 15% AKD and about 3% aluminum sulfate in the form of Fennosize KD 266 MB™ from Kemira) reagent. 15 mL 6% NaHCO₃ aq. solution was sprayed on the surface of rectangular cellulose sheet (about 11 g) by an airbrush sprayer at a pressure of 25 psi. The excess water was removed by a roller. Next, 15 mL of 2% aqueous solution of the emulsified blend of 15% AKD and about 3% aluminum sulfate in the form of Fennosize KD 266 MB™ from Kemira was sprayed on the activated surface of the cellulosic material. Three spray passes were used to coat the surface. The product was then dried in oven at 105° C. for 5 mins. In this case, moderate hydrophobicity was observed. Water absorption was observed after 3 hours.

### Example 4

Hydrophobization was done by activating the sheet with sodium bicarbonate followed by the treatment with AKD_ALS (i.e. the blend of 15% AKD and about 3% aluminum sulfate in the form of Fennosize KD 266 MB™ from Kemira) reagent. 15 mL 6% NaHCO₃ aq. solution was sprayed on the surface of rectangular cellulose sheet (about 11 g) by an airbrush sprayer at a pressure of 25 psi. The excess water was removed by a roller. Next, 15 mL of 8% aqueous solution of the emulsified blend of 15% AKD and about 3% aluminum sulfate in the form of Fennosize KD 266 MB™ from Kemira was sprayed on the activated surface of the cellulosic material. Three spray passes were used to coat the surface. The product was then dried in oven at 105° C. for 5 mins. In this case, extremely high hydrophobicity was observed showing lotus leaf type of wetting.

### Example 5

Hydrophobization was done without alkali activation of the sheet. 15 mL of 8% aqueous solution of the emulsified blend of 15% AKD and about 3% aluminum sulfate in the form of Fennosize KD 266 MB™ from Kemira was sprayed on the surface of rectangular cellulose sheet (about 11 g) by an airbrush sprayer at a pressure of 25 psi. The excess water was removed by a roller. Three spray passes were used to coat the surface. The product was then dried in oven at 105° C. for 5 mins. In this case, moderate to good hydrophobicity was observed with signs of water absorption in places. Thus, the alkali activation clearly enhances the hydrophobicity of cellulosic surface.

### Example 6

Modification was done in situ, where the blend of 15% AKD and about 3% aluminum sulfate in the form of Fennosize KD 266 MB™ from Kemira was reacted with sodium bicarbonate activated cellulose at 60° C. in water. 11.0 g of cellulose (0.25 mol) sheet was cut in a rectangular form and added to water (40 mL) under stirring at RT in a round bottom flask. 2.4 g of NaHCO₃ was added to the mixture. After 5 mins, 3.8 g of 15% AKD and about 3% aluminum sulfate in the form of Fennosize KD 266 MB™ from Kemira was added to the mixture at RT. Next, the mixture was heated at 60° C. for 15 mins. The mixture was filtered and the cellulosic product was collected and washed with water. The product was then dried in oven at 105° C. for 5 mins. In this case, the hydrophobicity was relatively less compared to the materials prepared by coating or spray technique. Also, the quality of the sheet degraded.

### Example 7

Hydrophobization was done by activating the sheet with sodium bicarbonate followed by AKD (i.e. emulsified form of 15% AKD in the form of Fennosize KD C125™ from Kemira) reagent. 15 mL 6% NaHCO₃ aq. solution was sprayed on the surface of rectangular cellulose sheet (about 11 g) by an airbrush sprayer at a pressure of 25 psi. The excess water was removed by a roller. Next, 15 mL of 5% aqueous solution of the emulsified form of 15% AKD in the form of Fennosize KD C125™ from Kemira was sprayed on the activated surface of the cellulosic material. Three spray passes were used to coat the surface. The product was then dried in oven at 105° C. for 5 mins. In this case, excellent hydrophobicity was obtained. The product showed rose patel (i.e. Wenzel) type of wetting.

### Example 8

10.0 g of cellulose (0.25 mol) of rectangular cellulose sheet was coated with 10 mL 5% isosorbide aq. solution. Next, 15 mL 6% sodium bicarbonate aq. solution was sprayed on the surface of rectangular cellulose sheet (about 11 g) by an airbrush sprayer at a pressure of 25 psi. The cellulose sheet is then pressed with roller to remove excess water. Subsequently, 15 mL of 5% aqueous solution of the emulsified blend of 15% AKD and about 3% aluminum sulfate in the form of Fennosize KD 266 MB™ from Kemira was sprayed on the activated surface of the cellulosic material. Three spray passes were used to coat the surface. The treated sheet was pressed once again and dried at 105° C. for 5 minutes. Once dried, the sheet showed excellent hydrophobicity. Preliminary test indicated that isosorbide treatment increased the tear strength of the material.

### Example 9

A softwood only cellulosic material was used. Use of softwood enhanced the strength of the sheet. 15 mL 6% NaHCO₃ aq. solution was sprayed on the surface of rectangular cellulose sheet (about 11 g) by an airbrush sprayer at a pressure of 25 psi. The excess water was removed by a roller. Next, 15 mL of 5% aqueous solution of the emulsified blend of 15% AKD and about 3% aluminum sulfate in the form of Fennosize KD 266 MB™ from Kemira was sprayed on the activated surface of the cellulosic material. Three spray passes were used to coat the surface. The product was then dried in oven at 105° C. for 5 mins. In this case, excellent hydrophobicity was obtained. Preliminary test indicated the tear strength of the sheet was increased due to the use of softwood.

| Exper- | | |
|---|---|---|
| iment | Reactants | Hydrophobicity |
| 1 | Cellulose mix, 6% NaHCO₃ aq. solution, | Excellent |
| | 5% aq. solution of blend of AKD (15%) | hydrophobicity |
| | and aluminum sulfate (3%) | |
| 2 | Cellulose mix, 6% NH₄OH aq. solution, | Excellent |
| | 5% aq. solution of blend of AKD (15%) | hydrophobicity |
| | and aluminum sulfate (3%) | |
| 3 | Cellulose mix, 6% NaHCO₃ aq. solution, | Moderate |
| | 2% aq. solution of blend of AKD (15%) | hydrophobicity |
| | and aluminum sulfate (3%) | |
| 4 | Cellulose mix, 6% NaHCO₃ aq. solution, | Extremely high |
| | 8% aq. solution of blend of AKD (15%) | hydrophobicity |
| | and aluminum sulfate (3%) | |
| 5 | Cellulose mix, 8% aq. solution of blend | Good |
| | of AKD (15%) and aluminum sulfate | hydrophobicity |
| | (3%) | |
| 6 | In situ treatment of cellulose mix 6%, | Low |
| | NaHCO₃ aq. solution, 5% aq. solution | hydrophobicity |
| | of blend of AKD (15%) and aluminum | |
| | sulfate (3%) | |
| 7 | Cellulose mix, 6% NaHCO₃ aq. solution, | Excellent |
| | 5% aq. solution of blend of AKD (15%) | hydrophobicity |
| 8 | Cellulose mix, 6% NaHCO₃ aq. solution, | Excellent |
| | 5% aq. solution of blend of AKD (15%) | hydrophobicity |
| | and aluminum sulfate (3%) | |
| 9 | Softwood, 6% NaHCO₃ aq. solution, | Excellent |
| | 5% aq. solution of blend of AKD (15%) | hydrophobicity |
| | and aluminum sulfate (3%) | |

*Cellulose mix is comprised of different cellulose materials such as mixture of hardwood and softwood pulps, hardwood pulps, cotton, newsprints, a blend of cellulose with high hemicellulose, cellulose with high lignin or a blend of high yield etc.

1. A biodegradable hydrophobic material comprising cellulose and a hydrophobic agent or sizing agent, wherein hydroxyl groups of the cellulose have been activated by a base, and then the hydroxyl groups have been reacted with the hydrophobic agent or sizing agent to cap the hydroxyl groups.

2. The biodegradable hydrophobic material of claim 1, wherein the cellulose is a cellulosic feedstock selected from newsprint, cellulose pulp, lignin-cellulose-hemicellulose or a mixture thereof.

3. The biodegradable hydrophobic material of claim 1, wherein the material is formed into an agricultural mulch film, a waterproof package, a disposable waterproof clothing, or a construction material.

4. The biodegradable hydrophobic material of claim 1, wherein the material is an agricultural mulch film.

5. The biodegradable hydrophobic material of claim 4, wherein the agricultural mulch film contains an herbicide, a pesticide, a fertilizer for plants, or a nutrient for plants.

6. The biodegradable hydrophobic material of claim 1, wherein the cellulose is softwood derived cellulosic feedstock.

7. The biodegradable hydrophobic material of claim 1, wherein the cellulose is activated using a basic or alkaline solution.

8. The biodegradable hydrophobic material of claim 1, wherein the cellulose is activated using sodium bicarbonate, sodium carbonate, ammonium hydroxide, sodium hydroxide, or a tertiary amine.

9. The biodegradable hydrophobic material of claim 1, wherein the hydrophobic agent or sizing agent is alkyl ketene dimer, alkenyl succinic anhydride, or epichlorohydrin, or a combination thereof.

10. The biodegradable hydrophobic material of claim 1, wherein the hydrophobic agent or sizing agent is alkyl ketene dimer.

11. The biodegradable hydrophobic material of claim 1, wherein the hydrophobic agent or sizing agent is a blend of alkyl ketene dimer and aluminum sulfate.

12. The biodegradable hydrophobic material of claim 1, further comprising isosorbide.

13. The biodegradable hydrophobic material of claim 1, which is in the form of a roll, sheet, film, powder or granule.

14. A method of making a biodegradable hydrophobic material, which comprises:
providing a starting material comprising cellulose,
contacting the starting material with a basic or alkaline solution to activate the hydroxyl groups of the cellulose and to obtain an activated material,
contacting the activated material with an hydrophobic agent or sizing agent to cap the hydroxyl groups to obtain a capped material, and
drying the material.

15. The method of claim 14, wherein the starting material is treated with isosorbide before contacting the material with the basic or alkaline solution.

16. The method of claim 14, wherein the step of contacting the material with the basic or alkaline solution, and the step of contacting the activated material with the hydrophobic agent or sizing agent, are conducted in water as a solvent.

17. The method of claim 14, wherein the step of drying comprises drying the material at a temperature 90-105° C. for 2-30 minutes.

18. The method of claim 14, which is a continuous or batch process.
